(19) United States
(12) Patent Application Publication
(10) Pub. No.: US 2026/0188665 A1
(43) Pub. Date: Jul. 2, 2026

(54) CATHODE ELECTRODE FOR A BATTERY SYSTEM OF AN ELECTRIC VEHICLE

(71) Applicant: GM Global Technology Operations LLC, Detroit, MI (US)

(72) Inventors: Caleb Reese, Ferndale, MI (US); Devendrasinh Darbar, Sterling Heights, MI (US); Sayed Youssef Sayed Nagy, Troy, MI (US); Raneen Taha, Sterling Heights, MI (US); Yoojin Kim, Shelby Township, MI (US); Daad Bourhan Haddad, Warren, MI (US); Gongshin Qi, Troy, MI (US); Lei Wang, Rochester Hills, MI (US)

(21) Appl. No.: 19/005,024

(22) Filed: Jan. 27, 2025

(51) Int. Cl. H01M 4/525; H01M 4/02; H01M 4/04; H01M 4/131; H01M 4/505

(52) U.S. Cl. CPC H01M 4/525; H01M 4/0471; H01M 4/131; H01M 4/505; H01M 2004/021; H01M 2004/028; H01M 2220/20

(57) ABSTRACT

A vehicle, comprising an electric motor; and a battery pack electrically coupled to the electric motor, wherein the battery pack comprises an electrochemical cell comprising: a cathode; an anode; and an electrolyte located between the cathode and the anode; wherein the cathode comprises a cathode active material, wherein the cathode active material comprises nickel and at least one electrochemically inactive dopant.

### INTRODUCTION

The subject disclosure relates to battery cell technologies, and particularly to cathodes for electrochemical cells for use in an electric vehicle.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

Battery cells include an anode, a cathode, an electrolyte composition, and optionally a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force. The cathode is one of the key components responsible for the electrochemical reactions that occur during charging and discharging processes. Modern automotive high voltage battery packs benefit from high energy density cathodes to improve overall performance and range.

There remains a continuing need for improved cathodes and methods of preparing cathodes for electrochemical cells.

### SUMMARY

An aspect provides a vehicle. The vehicle includes an electric motor and a battery pack that is electrically coupled to the electric motor. The battery pack includes an electrochemical cell. The electrochemical cell includes a cathode; an anode; and an electrolyte that is located between the cathode and the anode. The cathode includes a cathode active material. The cathode active material includes nickel and at least one electrochemically inactive dopant.

In an embodiment of the vehicle, the cathode active material does not include cobalt.

In an embodiment of the vehicle, the cathode active material includes a layered metal oxide represented by the formula Li(Ni_{1-z}Mn_{z})₁₋ₓMₓO₂, wherein 0.5≤z≤0.2, 0.001≤x≤0.05, and M is a dopant selected from titanium, boron, tantalum, molybdenum, tungsten, niobium, zinc, zirconium, aluminum, or a combination thereof.

In an embodiment of the vehicle, in the formula Li(Ni_{1-z}Mn_{z})₁₋ₓMₓO₂, M is aluminum and tantalum; or M is boron and molybdenum.

In an embodiment of the vehicle, in the cathode active material of the formula Li(Ni_{1-z}Mn_{z})₁₋ₓMₓO₂, 0.001≤x≤0.01.

In an embodiment of the vehicle, the cathode active material is derived from reaction of a cathode precursor with a dopant precursor, wherein the dopant precursor has an average particle size of 10 to 300 nanometers.

In an embodiment of the vehicle, the cathode active material is derived from heat treating a plurality of cathode active material particles in contact with a plurality of dopant nanoparticles.

Another aspect provides an electrochemical cell that includes a cathode, an anode, and an electrolyte that is located between the cathode and the anode. The cathode includes a layered oxide cathode active material. The layered oxide cathode active material. The layered oxide cathode active material includes nickel and at least one electrochemically inactive dopant.

In an embodiment of the electrochemical cell, the layered oxide cathode active material does not include cobalt.

In an embodiment of the electrochemical cell, the layered oxide cathode active material includes a metal oxide represented by the formula Li(Ni_{1-z}Mn_{z})₁₋ₓMₓO₂, wherein 0.5≤z≤0.2, 0.001≤x≤0.05, and M is a dopant that is selected from titanium, boron, tantalum, molybdenum, tungsten, niobium, zinc, zirconium, aluminum, or a combination thereof.

In an embodiment of the electrochemical cell, in the formula Li(Ni_{1-z}Mn_{z})₁₋ₓMₓO₂, M is aluminum and tantalum; or M is boron and molybdenum.

In an embodiment of the electrochemical cell, in the cathode active material of the formula Li(Ni_{1-z}Mn_{z})₁₋ₓMₓO₂, 0.001≤x≤0.01.

In an embodiment of the electrochemical cell, the layered oxide cathode active material is derived from reaction of a cathode precursor with a dopant precursor, wherein the dopant precursor has an average particle size of 10 to 300 nanometers.

In an embodiment of the electrochemical cell, the layered oxide cathode active material is derived from heat treating a plurality of cathode active material particles in contact with a plurality of dopant nanoparticles.

Another aspect provides a method for manufacturing a cathode active material. The method includes providing an active material precursor that includes nickel. The method includes providing a dopant precursor. The method includes mixing the active material precursor and the dopant precursor to form a mixture. The method also includes heating the mixture in the presence of oxygen to form the cathode active material.

In an embodiment of the method, the cathode active material does not comprise cobalt.

In an embodiment of the method, the cathode active material includes a metal oxide represented by the formula Li(Ni_{1-z}Mn_{z})₁₋ₓMₓO₂, wherein 0.5≤z≤0.2, 0.001≤x≤0.05, and M is a dopant that is selected from titanium, boron, tantalum, molybdenum, tungsten, niobium, zinc, zirconium, aluminum, or a combination thereof.

In an embodiment of the method, the active material precursor has an average particle size of 2 to 15 micrometers.

In an embodiment of the method, the dopant precursor has an average particle size of 10 to 300 nanometers.

In an embodiment of the method, the mixture of the active material precursor and the dopant precursor includes a plurality of cathode active material particles in contact with a plurality of dopant nanoparticles.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle configured in accordance with one or more embodiments;

FIG. 2 is a simplified configuration of an electrochemical cell of a battery pack in accordance with one or more embodiments;

FIG. 3A is an scanning electron microscopy (SEM) image of a baseline material from Example 2;

FIG. 3B is an SEM image of a titanium-doped material from Example 2;

FIG. 3C is an SEM image of molybdenum-doped material from Example 2; and

FIG. 4 is a plot of discharge capacity versus cycle number as described in Example 3.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As discussed previously, modern automotive high voltage battery packs prefer high energy density materials, such as nickel-based cathodes, to improve energy density and charge/discharge efficiency. Reducing the Ni content in cobalt-free layered oxide cathodes (NMx) helps lower production costs of such electrochemical cells, but it decreases energy density.

Introducing structural dopant materials that are electrochemically inactive can be used to further stabilize the crystal structure of the primary metal oxide particles. In addition, the dopants can be used to provide improved thermal stability, to stabilize the cathode electrolyte interphase (CEI) layer through surface reconstruction, and/or modify the primary particle morphology to inhibit intragranular cracking and/or improve electrolyte penetration. The present disclosure relates to a cathode that comprises a layered oxide cathode active material, wherein the layered oxide cathode active material comprise nickel and at least one electrochemically inactive dopant.

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

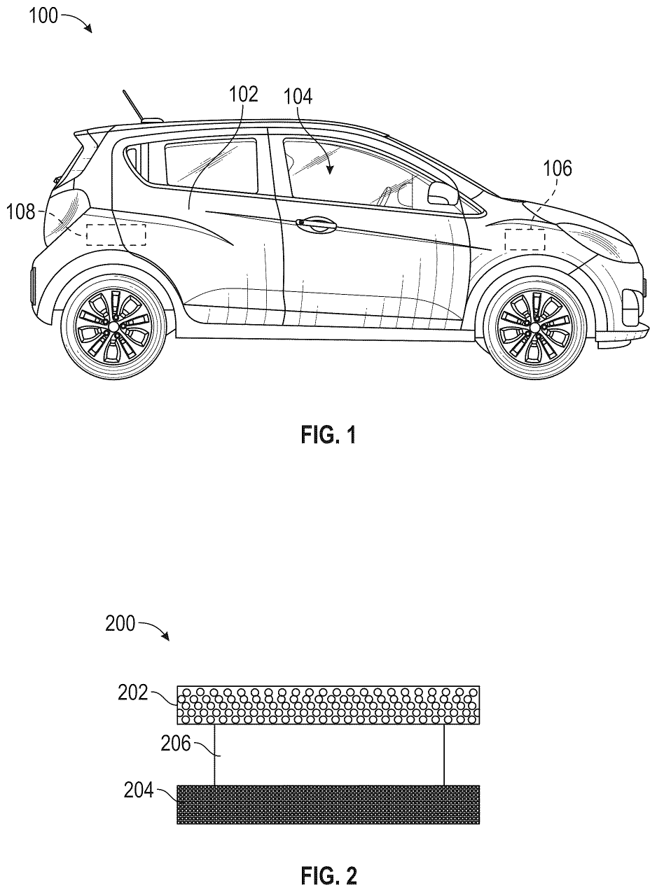

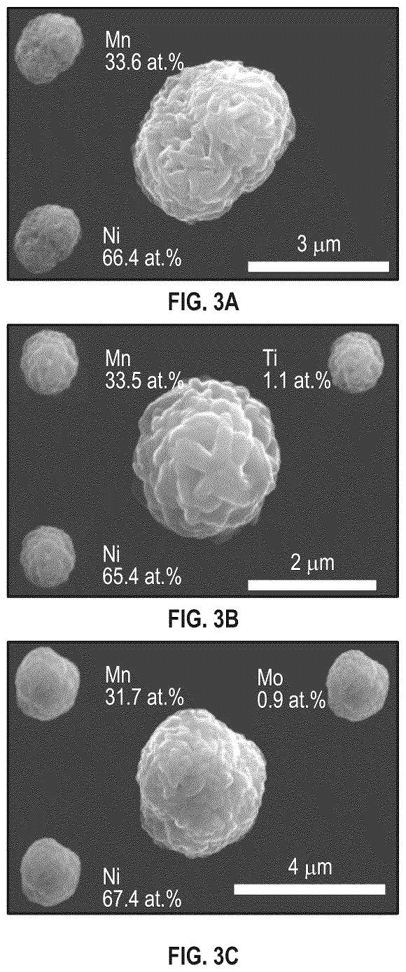

As discussed previously, in some embodiments, the battery pack 108 includes the cathode comprising a layered oxide cathode active material (refer FIG. 2). Example fabrication processes for the cathodes are discussed in greater detail with respect to FIGS. 3, 4, and 5.

FIG. 2 illustrates a simplified configuration of an electrochemical cell of a battery pack (e.g., the battery pack 108 of FIG. 1) in accordance with one or more embodiments. As shown in FIG. 2, an electrochemical cell 200 can include a cathode 202 (i.e., a positive electrode), an anode 204 (i.e., a negative electrode), and an electrolyte system 206 between the cathode 202 and the anode 204. While only a single electrochemical cell 200 is shown for convenience, it should be understood that a battery pack can contain any number of cells as needed to meet battery design constraints (e.g., capacity requirements).

The cathode 202 comprises a cathode active material, wherein the cathode active material comprises nickel and at least one electrochemically inactive dopant. As used herein, the term “electrochemically inactive dopant” means that the dopant is not actively involved in the redox cycling of the cathode active material. Instead, the electrochemically inactive dopants provide improved thermal stability, stabilize the CEI layer through surface reconstruction, and/or modify the primary particle morphology to inhibit intragranular cracking and/or improve electrolyte penetration.

The cathode active material may include a lithium-based active material that can sufficiently undergo lithium intercalation and deintercalation, alloying and dealloying, and/or plating and stripping, while functioning as the positive terminal of the electrochemical cell 200. The cathode 202 electroactive materials may include one or more transition metals, such as manganese (Mn), nickel (Ni), chromium (Cr), iron (Fe), vanadium (V), and combinations thereof. In some embodiments, the cathode 202 electroactive materials are free of cobalt (Co). In some embodiments, the cathode 202 includes one or both of lithium transition metal oxides with layered structure and lithium transition metal oxides with spinel phase. For example, in certain instances, the cathode 202 may include a spinel-type transition metal oxide, like lithium manganese oxide (Li₁₊ₓMn₂₋ₓO₄), where x is typically less than 0.15, including LiMn₂O₄ (LMO) and lithium manganese nickel oxide LiMn_{1.5}Ni_{0.5}O₄ (LNMO), in each case including a dopant as described herein. In some embodiments, the cathode 202 can include layered materials like lithium nickel oxide (LiNiO₂) including a dopant as described herein. Other known lithium-transition metal compounds such as lithium iron phosphate (LFP, LiFePO₄) or lithium iron fluorophosphate (Li₂FePO₄F) can also be used, each including a dopant as described herein. In some embodiments, the cathode 202 can include an electroactive material that includes manganese, such as a mixed lithium manganese nickel oxide (LiMn₂₋ₓNiₓO₄) including a dopant as described herein.

The cathode active material may include primary particles, such as those described above. In some embodiments, the cathode active material includes nickel in an amount from 50 mol % to 80 mol %, based on total moles of the cathode active material particles. For example, the cathode active material may include 50 mol % to 70 mol % of nickel, based on total moles of atoms in the cathode active material particles. In some embodiments, the cathode active material includes nickel in an amount from 50 atom % to 80 atom %, based on total atoms of the cathode active material particles. For example, the cathode active material may include 50 atom % to 70 atom % of nickel, based on total atoms in the cathode active material particles. In some embodiments, the cathode active material may include 50 atom % to 70 atom % of nickel, based on total atoms in the cathode active material particles (e.g., excluding lithium).

The dopant may be selected from titanium, boron, tantalum, molybdenum, tungsten, niobium, zinc, zirconium, aluminum, or a combination thereof. Combinations of dopants may be used. For example, the dopant may include aluminum and tantalum; or the dopant may include boron and molybdenum, but embodiments are not limited thereto.

The dopant may be included in the cathode active material in any suitable amount. For example, the dopant may be included in the cathode active material in an amount from 0.1 to 5.0 wt %, based on total weight of the cathode active material. In some embodiments, the dopant may be included in the cathode active material in an amount from 0.1 to 1.0 wt %, based on total weight of the cathode active material. In some embodiments, the dopant may be included in the cathode active material in an amount from 0.1 to 5.0 mol %, based on total moles of metalloid atoms in the cathode active material (e.g., excluding lithium). In some embodiments, the dopant may be included in the cathode active material in an amount from 0.1 to 1.0 mol %, based on total moles of metalloid atoms of the cathode active material (e.g., excluding lithium). In some embodiments, the dopant may be included in the cathode active material in an amount from 0.1 to 5.0 atom %, based on total atoms of metalloid atoms in the cathode active material (e.g., excluding lithium).

Typically, the cathode includes a layered metal oxide represented by the formula Li(Ni_{1-z}Mn_{z})₁₋ₓMₓO₂, wherein 0.5≤z≤0.2, 0.001≤x≤0.05, and M is a dopant selected from titanium, boron, tantalum, molybdenum, tungsten, niobium, zinc, zirconium, aluminum, or a combination thereof.

In some embodiments, in the formula Li(Ni_{1-z}Mn_{z})₁₋ₓMₓO₂, 0.4≤z≤0.2. Typically, in the formula Li(Ni_{1-z}Mn_{z})₁₋ₓMₓO₂, 0.4≤z≤0.25.

In some embodiments, in the formula Li(Ni_{1-z}Mn_{z})₁₋ₓMₓO₂, the dopant may be selected from titanium, boron, tantalum, molybdenum, tungsten, niobium, zinc, zirconium, aluminum, or a combination thereof. Typically, the dopant may be selected from titanium, boron, tantalum, molybdenum, or a combination thereof.

In some embodiments, in the formula Li(Ni_{1-z}Mn_{z})₁₋ₓMₓO₂, 0.001≤x≤0.05. Typically, in the formula Li(Ni_{1-z}Mn_{z})₁₋ₓMₓO₂, 0.001≤x≤0.01.

The cathode active material may be derived by the methods as provided in detail herein. Briefly, the cathode active material may be derived from reaction of a cathode precursor with a dopant precursor, wherein the dopant precursor has an average particle size of 10 to 300 nanometers. Typically, the cathode precursor has an average particle size of 2 to 15 micrometers. The cathode active material includes a plurality of the cathode active material particles in contact with a plurality of the dopant nanoparticles.

In some embodiments, the electrolyte 206 functions as a separator to provide a physical barrier between the cathode 202 and the anode 204. In some embodiments, the electrolyte 206 includes a dendrite-blocking layer, one or more interface layers, and/or one or more electrolyte layers (not separately shown). In some embodiments, the electrolyte 206, in addition to providing a physical barrier between the cathode 202 and the anode 204, can provide a minimal resistance path for the internal passage of lithium ions (and related anions) during cycling of the lithium ions to facilitate functioning of the electrochemical cell 200.

The electrolyte 206 provides a medium for the conduction of lithium ions through the electrochemical cell 200 between the cathode 202 and the anode 204 and may be in solid, liquid, or gel form. In aspects, the electrolyte 206 may include a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl4), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C2O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G₃)(TFSI), lithium bis(trifluoromethanesulfonyl)azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ lactones (e.g., γ butyrolactone, γ valerolactone), chain structure ethers (e.g., 1,2 dimethoxyethane, 1 2 diethoxyethane, ethoxymethoxyethane), cyclic ethers (e.g., tetrahydrofuran, 2 methyltetrahydrofuran), 1,3-dioxolane), or the like.

In some embodiments, the electrolyte may be a solid-state electrolyte. The solid-state electrolyte may include one or more solid-state electrolyte particles that may include one or more polymer-containing particles, oxide-containing particles, sulfide-containing particles, halide-containing particles, borate-containing particles, nitride-containing particles, hydride-containing particles, or a combination thereof. Exemplary solid-state electrolytes include, but are not limited to, LiTi₂(PO₄)₃, LiGe₂(PO₄)₃, Li₇La₃Zr₂O₁₂, Li₃xLa_{2/3}−xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or a combination thereof.

In some embodiments, the anode 204 includes an electroactive material such as a lithium host material capable of functioning as a negative terminal of the electrochemical cell 200. In various aspects, the electroactive material includes lithium and may be a lithium metal. In some embodiments, the anode 204 can include an electroactive lithium host material, such as graphite. In some embodiments, the anode 204 can include an electrically conductive material, as well as one or more polymeric binder materials to structurally hold the graphite material together. Negative electrodes may comprise greater than or equal to about 50% to less than or equal to about 100% of an electroactive material (e.g., graphite or graphite and lithiated silicon oxide blend), optionally less than or equal to about 30% of an electrically conductive material, and a balance binder. For example, in some embodiments, the anode 204 may include an active material including graphite particles intermingled with a binder material that may be polyvinylidene difluoride (PVdF), ethylene propylene diene monomer (EPDM) rubber, and/or carboxymethoxyl cellulose (CMC), a styrene-butadiene rubber (SBR), a compound and/or mixture of CMC and SBR, a nitrile butadiene rubber (NBR), lithium polyacrylate (LiPAA), sodium polyacrylate (NaPAA), sodium alginate, lithium alginate, and combinations thereof, by way of non-limiting examples. Suitable additional electrically conductive materials may include carbon-containing material and/or a conductive polymer. Carbon-containing materials may include, for example, electrically conductive carbon black, electrically conductive acetylene black, acetylene black, carbon black, graphite, graphene, graphene oxides, carbon nanofibers, carbon nanotubes, or the like. Examples of a conductive polymer include polyaniline, polythiophene, polyacetylene, polypyrrole, or the like. In certain aspects, mixtures of these conductive materials may be used.

In some embodiments, the cathode material, or material used to prepare the cathode, may include a solvent, a binder, and/or a slurry stabilizing agent (not separately shown). Solvents can be selected from known materials depending on the choice in the cathode active material. For example, the solvent for NCMA active materials may include N-Methyl-2-pyrrolidone (NMP). Other solvents, such as cyclic carbonates (e.g., ethylene carbonate (EC), propylene carbonate (PC), butylene carbonate (BC), fluoroethylene carbonate (FEC)); acyclic (i.e., linear) carbonates (e.g., dimethyl carbonate (DMC), diethyl carbonate (DEC), ethylmethylcarbonate (EMC)); aliphatic carboxylic esters (e.g., methyl formate, methyl acetate, methyl propionate); γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran, 1,3-dioxolane); or combination thereof, may be used.

The cathode active material may be intermingled with a binder and/or a conductive filler. Suitable binders include polyvinylidene fluoride (PVdF), polyethylene oxide (PEO), an ethylene propylene diene monomer (EPDM) rubber, carboxymethyl cellulose (CMC)), styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), sodium alginate, a combination thereof, or other suitable binders. An example of the conductive filler is a high surface area carbon, such as acetylene black, or the like. The binder may hold the electrode materials together, and the conductive filler may ensure good electron conduction between the positive-side current collector and the active material particles of the cathode.

In some embodiments, the electrochemical cell may further include a separator (not shown). Exemplary separators include a polymeric film, such as a polypropylene film or a coated polypropylene film. The separator may include a polyolefin-containing material having the general formula (CH₂CH_{R})ₙ, where R is an alkyl group. In some embodiments, the separator may include a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene.

The current collector of the cathode and/or the anode may be any suitable electrically conductive material. For example, current collector may include copper, nickel, titanium, platinum, gold, silver, magnesium, aluminum, vanadium, an alloy thereof, or a combination thereof. In some embodiments, the current collector may have a thickness of 6 micrometers (μm) to 20 μm, but the thickness is not limited to these ranges and any suitable thickness may be selected.

Also provided is a method of preparing a cathode of an electrochemical cell for an electric vehicle, wherein the electrochemical cell includes the cathode, an anode, and an electrolyte located between the cathode and the anode. The method includes providing an active material precursor comprising nickel, providing a dopant precursor, mixing the active material precursor and the dopant precursor to form a mixture, and heating the mixture in the presence of oxygen to form the cathode active material.

The heating of the mixture may be at any suitable temperature. For example, the mixture may be heated in the presence of oxygen (or air) at 800° C. to 1000° C. for 8 to 16 hours using a one-step process. Alternatively, the mixture may be heated in the presence of oxygen (or air) at 500° C. for 4 to 10 hours and then at 800 to 900° C. for 8 to 16 hours using a two-step process. Any suitable heating ramps may be used for the preparation, including, e.g., heating at a rate of 5 to 10° C. per minute. The reactions are conducted in the presence of oxygen, which may be in the form of the ambient atmosphere.

Any suitable precursor materials may be used to prepare the cathode active material. The active material precursor may be selected from carbonate, hydroxide, and/or oxide salts of the appropriate metal compounds. Typically, the active material precursor has an average particle size of 2 to 15 micrometers. The lithium precursors include lithium salts such as one or more of lithium hydroxide, lithium carbonate, lithium nitrate, or the like, or a combination thereof. The dopant precursors include ammonium, oxalate, oxide, nitrate, or the like salts of the dopant element compounds. Typically, the dopant precursor has an average particle size of 10 to 300 nanometers.

The discharge capacity C (measured in amp-hour, or Ah) of a battery can be evaluated at various currents or, more commonly, at various C rates. The C rate is conventionally used to describe battery loads or battery charging in terms of time to charge or discharge C amp-hour. The C rate has the units of amp (or ampere), A, and is capacity C divided by time in hours. A C rate of 1 C means 1 hour to discharge C amp-hour. Other C rates can be employed to evaluate discharge capacity, such as C/2 (2 hours of discharge), C/6 (6 hours of discharge), C/10 (10 hours of discharge), or the like.

### EXAMPLES

### Example 1

### Preparation of Nickel-Rich, Cobalt-Free Oxides

Lithium-manganese nickel-rich metal oxide particles were prepared as follows. Anhydrous lithium hydroxide was combined with (Ni_{0.66}Mn_{0.34})OH₂ and a specified amount (1 wt %) of selected dopant (MoO₃, TiO₂, or B₂O₃) to provide a reaction mixture. The respective reaction mixtures were then calcined in a single-step process at 875° C. in the air for 15 hours to provide the doped cathode active materials.

The doped cathode active materials were evaluated by SEM, which revealed that doping with Mo or Ti resulted in modification of the surface and morphology of the primary active particles. As shown in FIGS. 3A to 3C, the average particle size in the absence of a dopant (FIG. 3A) decreased upon doping with 1.1 wt % of titanium (FIG. 3B) and increased upon doping with 0.9 wt % of molybdenum (FIG. 3C).

### Example 2

### Formation of Electrochemical Cells

Each of the doped cathode active materials were separately combined with carbon black (CB) and polyvinylidene fluoride (PVDF) at weight ratios of LMR:CB:PVDF or 94:3:3 to each form a cathode layer on a cathode current collector. These cathodes were assembled into an electrochemical cell having a graphite based anode, a microporous polypropylene monolayer) separator, and a LiPF₆ based electrolyte. A constant current and constant voltage (CCCV) protocol was used to charge the cells at a constant current using a C/20 charge rate to a potential of about 4.4 V, then constant voltage charge at 4.4 V until the current reached C/50. The cells were subsequently discharged at a constant current using a C/20 discharge rate to 2.5 V. A total of 2 such charge and discharge cycles were performed during formation.

### Example 3

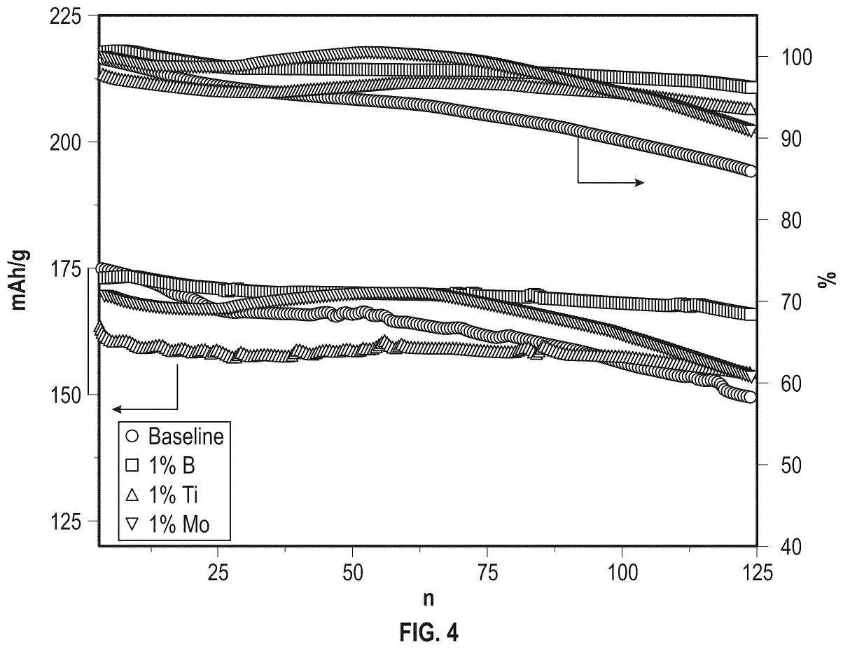

Electrochemical cells prepared in Example 2 were tested were tested for life cycle protocol by cycling between 2.5-4.4 V using the following CCCV protocol: A constant current and constant voltage (CCCV) protocol was used to charge the cells at a constant current using a C/3 charge rate to a potential of about 4.4 V, then constant voltage charge at 4.4 V until the current reached C/20. The cells were subsequently discharged at a constant current using a C/3 discharge rate to 2.5 V. FIG. 4 shows the discharge capacity in milliampere-hours/gram of the battery cell on the y axis and cycle number on the x-axis, and further shows the discharge capacity retention as a percentage of initial discharge capacity on the y axis versus cycle number on the x-axis. The dopants were found to improve the capacity retention when cycled between 2.5 and 4.4 V at a C/3 rate.

The terms “a” and “an” do not denote a limitation of quantity, but rather denote the presence of at least one of the referenced items. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears. Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A vehicle, comprising:
an electric motor; and
a battery pack electrically coupled to the electric motor, wherein the battery pack comprises an electrochemical cell comprising:
a cathode;
an anode; and
an electrolyte located between the cathode and the anode;
wherein the cathode comprises a cathode active material, wherein the cathode active material comprises nickel and at least one electrochemically inactive dopant.

2. The vehicle of claim 1, wherein the cathode active material does not comprise cobalt.

3. The vehicle of claim 1, wherein the cathode active material comprises a layered metal oxide represented by the formula Li(Ni_{1-z}Mn_{z})₁₋ₓMₓO₂, wherein 0.5≤z≤0.2, 0.001≤x≤0.05, and M is a dopant selected from titanium, boron, tantalum, molybdenum, tungsten, niobium, zinc, zirconium, aluminum, or a combination thereof.

4. The vehicle of claim 3, wherein M is:
aluminum and tantalum; or boron and molybdenum.

5. The vehicle of claim 3, wherein in the cathode active material, 0.001≤x≤0.01.

6. The vehicle of claim 1, wherein the cathode active material is derived from reaction of a cathode precursor with a dopant precursor, wherein the dopant precursor has an average particle size of 10 to 300 nanometers.

7. The vehicle of claim 1, wherein the cathode active material is derived from heat treating a plurality of cathode active material particles in contact with a plurality of dopant nanoparticles.

8. An electrochemical cell, comprising:
a cathode;
an anode; and
an electrolyte located between the cathode and the anode;
wherein the cathode comprises a layered oxide cathode active material, wherein the layered oxide cathode active material comprises nickel and at least one electrochemically inactive dopant.

9. The electrochemical cell of claim 8, wherein the layered oxide cathode active material does not comprise cobalt.

10. The electrochemical cell of claim 8, wherein the layered oxide cathode active material comprises a metal oxide represented by the formula Li(Ni_{1-z}Mn_{z})₁₋ₓMₓO₂, wherein 0.5≤z≤0.2, 0.001≤x≤0.05, and M is a dopant selected from titanium, boron, tantalum, molybdenum, tungsten, niobium, zinc, zirconium, aluminum, or a combination thereof.

11. The electrochemical cell of claim 10, wherein M is:
aluminum and tantalum; or
boron and molybdenum.

12. The electrochemical cell of claim 10, wherein in the layered oxide cathode active material, 0.001≤x≤0.01.

13. The electrochemical cell of claim 8, wherein the layered oxide cathode active material is derived from reaction of a cathode precursor with a dopant precursor, wherein the dopant precursor has an average particle size of 10 to 300 nanometers.

14. The electrochemical cell of claim 8, wherein the layered oxide cathode active material is derived from heat treating a plurality of cathode active material particles in contact with a plurality of dopant nanoparticles.

15. A method for manufacturing a cathode active material, the method comprising:
providing an active material precursor comprising nickel;
providing a dopant precursor;
mixing the active material precursor and the dopant precursor to form a mixture; and
heating the mixture in the presence of oxygen to form the cathode active material.

16. The method of claim 15, wherein the cathode active material does not comprise cobalt.

17. The method of claim 15, wherein the cathode active material comprises a metal oxide represented by the formula Li(Ni_{1-z}Mn_{z})₁₋ₓMₓO₂, wherein 0.5≤z≤0.2, 0.001≤x≤0.05, and M is a dopant selected from titanium, boron, tantalum, molybdenum, tungsten, niobium, zinc, zirconium, aluminum, or a combination thereof.

18. The method of claim 15, wherein the active material precursor has an average particle size of 2 to 15 micrometers.

19. The method of claim 15, wherein the dopant precursor has an average particle size of 10 to 300 nanometers.

20. The method of claim 15, wherein the mixture of the active material precursor and the dopant precursor comprises a plurality of cathode active material particles in contact with a plurality of dopant nanoparticles.
